(19) United States
(12) Patent Application Publication
(10) Pub. No.: US 2022/0308815 A1
(43) Pub. Date: Sep. 29, 2022

(54) COORDINATED DISPLAY OF MESSAGES

(71) Applicant: Hewlett-Packard Development Company, L.P., Spring, TX (US)

(72) Inventors: Jeremy Geltman, San Diego, CA (US); Steven Romero, San Diego, CA (US); Sogra Nishath, San Diego, CA (US); Evangelina Garcia, San Diego, CA (US)

(73) Assignee: Hewlett-Packard Development Company, L.P., Spring, TX (US)

(21) Appl. No.: 17/615,596

(22) PCT Filed: Sep. 19, 2019
(86) PCT No.: PCT/US2019/051836

§ 371 Date: Dec. 1, 2021

(51) Int. Cl. G06F 3/14

(52) U.S. Cl. CPC G06F 3/14; H04N 1/0049

(57) ABSTRACT

An example is directed to a computing device having non-transitory computer-readable medium storing a set of instructions executable by a processor to cause the computing device to receive, from a server in communication with the computing device and an appliance, data indicative of a message that is specific to the appliance and associated with an operational state of the appliance. The instructions are further executed by the processor to provide the message on a display of the computing device as coordinated with a visual indication on the appliance associated with the operational state of the appliance using the received data.

### BACKGROUND

Appliances may have instructions for setting up the appliances and/or for other purposes, such as for trouble shooting. In many instances, the appliances may display light based patterns or animations to indicate operational states of the appliances.

### BRIEF DESCRIPTION OF FIGURES

Various examples may be more completely understood in consideration of the following detailed description in connection with the accompanying drawings, in which:

FIG. 1 illustrates an example environment for coordinating messages, in accordance with the present disclosure;

FIG. 2 illustrates an example computing device including non-transitory computer readable medium storing executable code, in accordance with the present disclosure;

FIG. 3 illustrates an example appliance, in accordance with the present disclosure;

FIGS. 4A-4D illustrate example coordinated messages of a computing device and visual indications of an appliance, in accordance with the present disclosure; and

FIG. 5 illustrates an example server in an environment for coordinating messages, in accordance with the present disclosure.

While various examples discussed herein are amenable to modifications and alternative forms, aspects thereof have been shown by way of example in the drawings and will be described in detail. It should be understood, however, that the intention is not to limit the disclosure to the particular examples described. On the contrary, the intention is to cover all modifications, equivalents, and alternatives falling within the scope of the disclosure including aspects defined in the claims. In addition, the term “example” as used throughout this application is by way of illustration, and not limitation.

### DETAILED DESCRIPTION

Aspects of the present disclosure are applicable to a variety of different apparatuses and methods involving a message displayed on a computing device that is coordinated with a visual indication on an appliance. In certain non-limiting examples, aspects of the present disclosure may involve two-way communications between the appliance and the computing device such that user instructions for interacting with the appliance are provided to the user on the display of the computing device and which are synchronized with visual lights on the appliance. In particular examples, the computing device uses a near-field discovery technique to identify a specific appliance, and is provided with specific instructions in response to the identification. In some applications, a plurality of different sets of instructions are stored in a cloud network, with each of the sets being specific to a particular appliance and to a current operational state of the appliance, and are provided to a specific computing device in response to identification of the particular appliance.

Providers of appliances, such as printers, copiers, thermostats, refrigerators, 3-dimensional (3D) printers and multifunction devices, may provide users with instructions for how to operate the appliance including user instructions for setting up the appliance, trouble shooting issues, and/or maintenance. The user instructions may be different for each specific type of appliance. Print-outs for each of the different instructions and in different spoken language may be provided with the specific appliance. Consumers are increasingly interested in smart appliances that may be remotely-accessed and/or have programmable functionality. With a smart appliance, a user may activate different features or otherwise establish a user session with the appliance, and the user instructions may be provided to the user in response to identifying a specific appliance and via communication with external circuitry, such as a server of a cloud network that stores a plurality of instructions for guiding the user. Examples in accordance with the present disclosure allow for dynamic interactions between a computing device and an appliance in which two-way communication is provided for coordinating visual displays on the computing device and the appliance. The coordinated visual displays that are specific to the appliance may guide the user through various interactions with the appliance and may allow for feedback between the appliance and computing device to verify that the interactions are completed successfully and/or guide the user through corrective interactions when the interaction is not successful or causes an error.

In specific examples, the appliance may communicate with the computing device and the computing device communicates with the cloud network such that user instructions are provided to the user in a manner that the display on the computing device and visual indications on the appliance are synchronized. In further and related specific examples, the appliance may not have a screen-based user interface, and instead, may convey information to the user using different patterns of lights. The computing device, at different times, may receive user instructions for a variety of different appliances. The computing may use near communication or local area communication discovery techniques, such as Bluetooth Low Energy (BLE) or wireless networking (WiFi) communications, to identify the specific nearby appliance. As an example, for appliance that is not yet set up, the user instructions guide the user through the set up process. In response to the identification of the appliance, the computing device is provided with user instructions from the cloud network and specific to the identified appliance. As a specific example, the user instructions are provided in the form of animations that are coordinated with the visual light patterns on the specifically identified appliance. The appliance may have a variety of sensors to detect user inputs and/or physical interactions with the appliance, which cause revisions to the user instructions displayed on the computing device. User physical interactions with either the computing device or the appliance cause changes in the display and visual indication on both the computing device and the appliance.

A specific example is directed to a computing device in communication with a server and an appliance. The computing device receives, from a server in communication with the computing device and the appliance, data indicative of a message, which may be a first message of a plurality of messages. The message being specific to the appliance and associated with an operational state of the appliance. The computing device provides the message on a display of the computing device as coordinated with a visual indication on the appliance associated with the operational state of the appliance using the received data. The message may be a visualization and/or an animation that is synchronized and/or concurrently occurring with the visual indication on the appliance. The coordination may occur through two-way communication between the appliance and the computing device. For example, the computing device identifies the particular appliance in response to information from the appliance. The appliance may periodically output the identifying information. In specific examples, the messages displayed on the computing device and the visual indications on the appliance are indicative of user instructions to physically interact with hardware of the appliance. Changes in the visualizations may be triggered by user inputs to the computing device and/or the appliance, which cause changes on both the computing device and the appliance.

Another related example is directed to an appliance that includes a memory and a processor coupled to the memory. The processor executes instructions stored on the memory to output information that identifies the appliance to a computing device. The processor further provides data indicative of an operational state of the appliance to the computing device and/or a server in communication with the appliance and the computing device. The operational state of the appliance may be communicated in response to the appliance receiving data indicative of the computing device identifying the appliance. For example, the data may include a confirmation of identification of the appliance communicated directly from the computing device to the appliance (and in response to the output information). In specific examples, the data indicative of the operational state is communicated from the appliance to the computing device, and the computing device may communicate the same to the server. In other examples, the operational state is communicated directly to the server from the appliance, and the operational state is then communicated to the appliance as part of a message and/or used to identify the message, as further described herein. The processor further provides the visual indication of the operational state on the appliance. The visual indication is coordinated with a message provided on a display of the computing device. The message displayed on the computing device is specific to the appliance and associated with the operational state of the appliance. As further described herein, the visual indication may be provided by a plurality of light sources located at different locations of the appliance, and which provide different patterns of light. The appliance may further include a sensor or a plurality of sensors in communication with the processor and which are used to detect different operational states. The operational states may revise or change overtime due to user physical interactions with the appliance, communication connectivity or power changes, and/or errors caused by the appliance or a user.

A variety of examples are directed to an apparatus that includes the above-described server. As may be appreciated, the server may include a plurality of different servers that are located at the same or different locations. The server, which may be referred to as a “cloud server”, provides different functionalities. The server may include a memory and a processor that executes instructions stored on the memory to identify an appliance based on information as communicated from the computing device and to receive, from the appliance directly or indirectly, data indicative of an operational state of the appliance. The operational state may indicate, to the server, which message(s) to send to the computing device, such as indicating the appliance is to be set up and/or an issue with the appliance to resolve. The processor provides, to the computing device, data indicative of a message that is specific to the appliance and that may be for a user. The message includes a visualization to provide on a display of the computing device that is coordinated with a visual indication on the appliance. The message and the visual indication are associated with the operational state of the appliance.

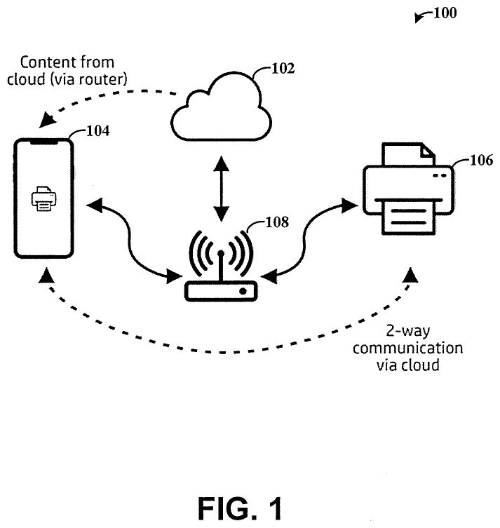

Turning now to the figures, FIG. 1 illustrates an example environment for coordinating messages, in accordance with the present disclosure. The example environment 100 includes a server associated with a cloud network 102, a computing device 104, and an appliance 106. The computing device 104 and the appliance 106 may directly communicate with one another via a router 108 and may communicate with the server via the router 108.

The environment 100 may be used to assist and/or guide a user of the computing device 104 through user interactions with the appliance 106. More specifically, the computing device 104 may execute an application program associated with the cloud network 102. The cloud network 102 may have content related to a plurality of different appliances, including the specific appliance 106. In a number of examples, the cloud content includes messages that include multiple successive user instructions for the user and are related to specific appliances. The messages and/or user instructions may be used to guide the user through different processes, such as setting up the appliance 106, resolving a particular issue with the appliance 106, and/or updating the appliance 106. The user instructions, provided as messages, may be updated over time based on feedback of user success or failure to follow the instructions and/or specific feedback on the user following the user instruction set, such as when a user already completes a task and/or completes tasks in different order(s) than the successive instructions provide. The cloud content may include different sets of messages which are specific to different appliances and different operational states of the appliances. A specific message and/or messages are provided to the computing device 104 in response to identification of a specific, and optionally nearby, appliance 106 and a current operational state of the appliance 106.

As an example, the computing device 104 identifies the specific appliance 106 by a near-field and/or local area communication technique. The appliance 106 may periodically communicate identifying information using the communication technique, such as WiFi and/or BLE. The identifying information is received by the computing device 104 and which may directly identify the appliance 106. A visualization of the appliance 106 is displayed on the graphical interface of the computing device 104. The computing device 104 may further communicate a confirmation message to the appliance 106 which confirms the computing device has identified the appliance 106. In other examples and/or in addition, the computing device 104 communicates the identifying information to the server associated with the cloud network 102 via the router 108. The server uses the identifying information to identify the specific appliance 106 and provides data indicative of a message back to the computing device 104 to display identification of the appliance 106. The display, for example, may be an image and/or animation of the appliance 106. The data indicative of the message may be selected by the server based on a current operational state of the appliance 106.

The appliance 106 may have different operational states. An operational state includes or refers to a state describing an operational behavior and/or property of the appliance. Example operational states include an on-state, an off-state, and an error state. Other more specific operational states may include “connected to the application program but not WiFi”, a data receiving state, a set up state, low (or no) ink state, low (or no) printing fluid, such as toner, state load paper state, and/or other states associated with components of the appliance. In some examples, the set-up state may include a plurality of states or sub-states that are indicative of a set up process for setting up the appliance 106. The appliance 106 may change operational states in response to user inputs to the appliance 106 and/or the computing device 104. The user, for example, may verify to connect or add the appliance 106 to a user account or user session associated with the application program on the computing device 104, which causes a change in operational state of the appliance 106.

The appliance 106, in some specific examples, may not have a graphical user interface or may have a simple graphical user interface. The appliance 106 may provide visual indications of the operational state, such as using a plurality of light sources. In a specific example, the appliance 106 includes a plurality of light emitting diodes (LEDs) that provide different light patterns, moving light patterns, and/or colors for different operational states. The visual indications may coordinate with the visualization provided by the computing device 104. For example, an on-screen visualization, such as an animation, is provided on a display of the computing device 104 that is coordinated and/or synchronized with the visual indication on the appliance 106. A user input and/or physical interaction with the computing device 104 and/or the appliance 106 may cause a reaction of the visualization on both the computing device 104 and the appliance 106.

Such an environment may be used to guide a user through setting up the appliance 106 and/or other interactions with the appliance 106 through synchronized visualizations driven by the two-way communication between the appliance 106 and computing device 104. Feedback on success or failure of a user interaction may be provided, in real time, to the user. For example, in response to a failure to complete an action, the user may be guided on how to resolve the issue or otherwise correct the failure. As the visualizations are coordinated between the computing device 104 and the appliance 106, the information on the display may be minimized to reduce the amount of information communicated to the computing device 104 from the server of the cloud network 102. Furthermore, as the cloud network 102 may store user instructions sets for different appliances and in different languages, an amount of printed-out instructions may be reduced and/or eliminated. The cloud network 102 may further perform analytics on the success and failures of user interactions over time to identify problem areas and to revise the visualization provided. The revisions may be different for different geographic regions and/or types of users.

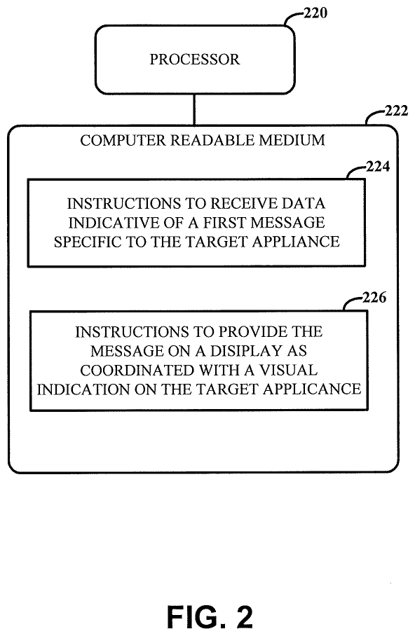

FIG. 2 illustrates an example computing device including non-transitory computer-readable medium storing executable code, in accordance with the present disclosure. The computing device may include a mobile device, such as a smartphone, a tablet, a smartwatch, and/or a laptop computer or other types of computing devices such as desktop computers that executes an application program. The computing device is in communication with a server, such as a server in a cloud network and that has data associated with a plurality of different appliances.

The computing device has a processor 220 and computer readable medium 222 storing a set of instructions 224, 226. The computer readable medium 222 may, for example, include read-only memory (ROM), random-access memory (RAM), electrically erasable programmable read-only memory (EEPROM), Flash memory, a solid state drive, and/or discrete data register sets. At 224, the computing device may receive, from a server in communication with the computing device and an appliance, data indicative of a message of the computing device. The message is specific to the appliance, as identified using near-field or local area communication, and associated with a current operational state of the appliance. In specific examples, the appliance is identified by the computing device. For example, the computing device may identify the appliance responsive to information received directly from the appliance. In a number of examples, the computing device, in response to the identification, may provide wireless credentials to the appliance such that the appliance may also communicate with the server. In addition and/or alternatively, the computing device may communications data to the appliance that indicates and/or confirms the computing device identifies the appliance, as further described herein. At 226, the computing device provides the message on a display of the computing device. The message is coordinated with the operational state of the appliance using the received data. The message may include a visualization, such as a graphic display or an animation, that is provided on the display of the computing device and that is synchronized to the visual indication on the appliance. The synchronization is based on the two-way communication between the appliance and the computing device. In a specific example, the synchronization may be responsive to a user input to the computing device and/or the appliance.

The message may be indicative of a user instruction to physically interact with the appliance, such as a physical interaction with hardware of the appliance. A plurality of user instructions may be provided to the user that include multiple successive user instructions and which are revised responsive to the user interaction. In some examples, the plurality of user instructions are communicated to the computing device in the originally communicated data from the server. In other examples and/or in addition, the plurality of user instructions are communicated to the computing device as different data messages from the server at different times. For example, the computing device may receive data, from the server, indicative of a second message for the user that is associated with a revised operational state of the appliance caused by a first user input to the appliance and/or the computing device. The second message is communicated as part of the data originally sent or additionally sent data from the server. In related examples, the data from the server includes a plurality of visualizations to display, an indication of an order of the visualizations to display and/or an indication of an operational state of the appliance that results in displaying the respective visualization. Using the above example, the computing device is instructed by the original data from the server to provide a second message in response to the revised operational state. In other examples, the computing device communicates the revised operational state to the server, resulting in additional data being sent from the server that includes the second message.

The computing device provides the second message on the display of the computing device as coordinated with a revised visual indication on the appliance. The second message and the revised visual indication are associated with the revised operational state. More specifically, the computing device changes a graphic on the display of the computing device from the message to the second message responsive to first user input to the computing device and/or the appliance. As a specific example, in response to the first user input to the appliance, the appliance revises operational states and communicates the same to the computing device. The computing device may output data indicative of the first user input and/or the revised operational state to the server and/or directly to the appliance, which causes the visual indication on the appliance to change and to coordinate with the second message.

The following is a specific example of appliance and/or computing device responses to user input, such as the user physically interacting with the appliance. A user may be in a particular location with an appliance which is a printer. The user may have an application program on a mobile device or has access thereto that provides sessions with various appliances. In response to the user and the mobile device being within a threshold distance of the printer, the mobile device identifies a beacon output by the printer. The printer periodically outputs beacons having identifying information using a near-field or local area communication technique. The mobile device identifies the make and/or model of the printer via information in the beacon and using information stored by the application program. The information may be locally stored on the mobile device and/or accessed from a cloud network. The mobile device communications data to the printer that indicates or confirms the mobile device identifies the appliance. In response to the data indicative of the identification (and the printer having or being provided WiFi access), the printer and mobile device communicate. For example, the printer communicates its current operational status is a powered-on but is not set up state. The mobile device communicates the current operational state of the printer to a server of the cloud network, and is provided with messages indicative of user instructions for setting up the printer. The user instructions may include a plurality of messages provided at different times from the server and/or the plurality of messages and an indication of an order of the messages provided at one time, such as a general order and/or an association between an operational state of the printer and providing a message. The server and/or the mobile device may provide each message in response to verification that the user successfully (or unsuccessfully) completed an action. In some examples, in which a set of visualizations is provided at once from the server, the server may revise the set of visualizations in response to communication from the mobile device indicating a failed instruction and/or that a user action associated with a user instruction has already occurred. The mobile device may determine to communicate with the server in response to an operational state of the printer that does not match one of messages associated with data sent from the server.

As a further specific example, the server provides data indicative of a message to the mobile device which includes a visualization instructing the user to load paper into the printer tray. The visualization is provided on a display of the mobile device which includes a graphic illustration or animation of the printer and that coordinates with a visual indication on the printer. The visualization of the printer may include an animation of the printer showing the same visual lights on the animation as are being concurrently displayed on the same location of the printer. In this manner, the visualization is a mirrored image of the printer with the visual lights which guide the user to the location of where to put the paper. In response to the user correctly placing paper in the guided location, the printer changes operational states, which results in changes in the visual indication provided by the printer. The changed operational state is communicated to the mobile device, which results in a revised display on the mobile device to match the visual indication on the printer. As an example, a light on the lid of the printer may indicate to the user a lid to open to install ink. This same image of the printer, having the light at the same location on the lid, is displayed on the mobile device with an animation and/or words guiding the user to lift the lid for installing the ink. As a specific example, an animation shows the lid being lifted or moving.

In other examples, the user may have already installed the ink. The printer detects the installation of ink and communicates the same to the mobile device, which results in the visualization of the user instruction(s) on installing the ink being skipped and/or otherwise not provided to the user. As another example, the printer sensor may be used to detect incorrect installation of the ink, which is communicated to the mobile device and used to provide revised visualizations of user instructions to guide the user to fix the installation.

Similarly, user inputs to the mobile device may cause changes in the visual indication on the printer. As a specific example, in response to the user providing an input to the mobile device indicating to add the printer to an account associated with the application program, the visual indications on the printer may change color and/or pattern indicating that the printer is connected to application program but is not connected on WiFi, and a message is concurrently displayed on the mobile device indicating the same, among other visual indications.

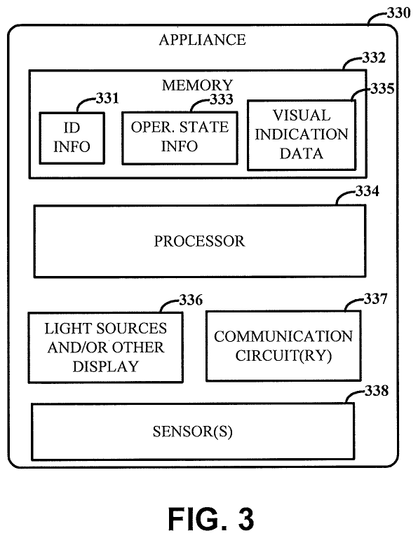

FIG. 3 illustrates an example appliance, in accordance with the present disclosure. The appliance 330 may include a printer, such as an inkjet printer, a laser printer, and/or a 3D printer, a smart television, a smart washer or dryer, a smart refrigerator, a copier, a thermostat, a security system, etc. In various examples, as further described herein, the appliance 330 includes a sensor, WiFi or other Internet communication connections, and an operating system.

As shown, the appliance 330 has a memory 332 and a processor 334. The memory 332 stores executable instructions 331, 333, 335. The instructions 331, 333, 335 may be associated with identifying the appliance, providing data indicative of operational states of the appliance, and providing visual indications of the operational states.

The processor 334 is coupled to the memory 332 and executes the instructions 331 to output information that identifies the appliance to a computing device. In a number of examples, the identifying information is periodically output by the appliance using a near field or local area communication technique, such as BLE and/or WiFi messages. The output information may directly identify the specific appliance, such as the type of appliance, the brand, the model, etc. In other examples, the computing device communicates the output information to the cloud network, which is used to identify the specific appliance and/or specific instructions to provide a user.

The processor 334 further executes the instructions 333 to provide data indicative of the operational state of the appliance to the computing device. The data indicative of the operational state is provided in response to the appliance receiving data indicative of the computing device identifying the appliance 330, such as a confirmation of the identification. In some examples, the operational state is communicated to a server in communication with the computing device and the appliance 330. The server may be associated with a cloud network. In specific examples, the processor 334 communicates the operational state information directly to the computing device, which communicates the operational state information to the server. In other examples, the processor 334 communicates the operational state information directly to the server via a router and WiFi connection. As further described herein, the server may identify a message to provide on a display of the computing device that is specific to the appliance 330 and associated with the operational state of the appliance 330. The appliance 330 may further include a communication circuit 337 to communicate the data indicative of the operational state of the appliance 330, such as communicating to the computing device and/or the server.

In specific examples, the appliance 330 includes a sensor and/or a plurality of sensors 338 to detect the operational state of the appliance 330. For example, a printer may include a plurality of different sensors used to sense the position of lids, the placement of paper and/or ink, among other states. The sensor 338 may be used to detect a revised operational state of the appliance 330, which may be in response to a user performing an action. The revised operational state is communicated by the communication circuit 337 to the computing device and/or the server. In related examples, the computing device and appliance 330 are in communication, such as WiFi communication via a router. The operational state information is communicated to the computing device, and which may cause revisions in the visual display provided by the computing device. The processor may be coupled to the sensor 338 to detect the revised operational state in response to a user interaction with hardware of the appliance 330, and the communication circuit 337 is to communicate the data indicative of the revised operational state of the appliance 330 to the computing device as feedback. The feedback may cause a revision to a display of the computing device, thereby synchronizing a visualization provided by the computing device with a revised visual indication provided by the appliance 330 and associated with the revised operational state of the appliance 330. In some examples, the server may communicate data indicative of a plurality of messages for visually displaying, with an order for displaying the messages and/or as associated with different operational states of the appliance 330. The computing device, in such examples, may respond to the revised operational state of the appliance 330 without further communicating with the server to provide different visualizations.

The processor 334 further executes the instructions 335 to provide a visual indication of the operational state of the appliance 330. The visual indication is coordinated with the message provided on the display of the computing device. The visual indication of the operational state may be provided by a plurality of light sources and/or other types of displays 336. The plurality of light sources, such as LEDs may provide different patterns and/or colors of light that are coordinated with a message provided on the display of the computing device. For more general and specific information on example light patterns in electronic devices, reference is made to PCT Application Number PCT/US2018/032746, entitled “Moving Light Patterns Creation”, filed on May 15, 2018, which is fully incorporated herein by reference.

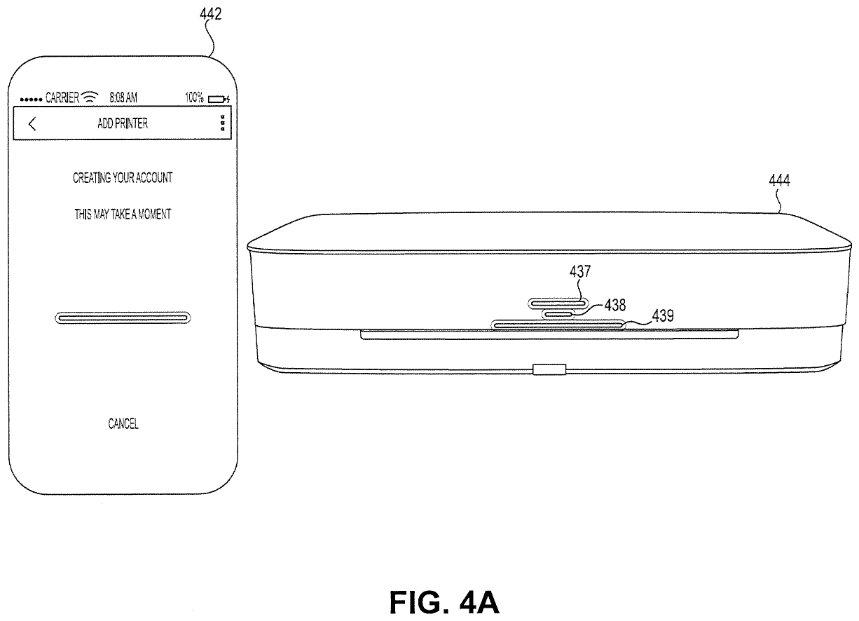

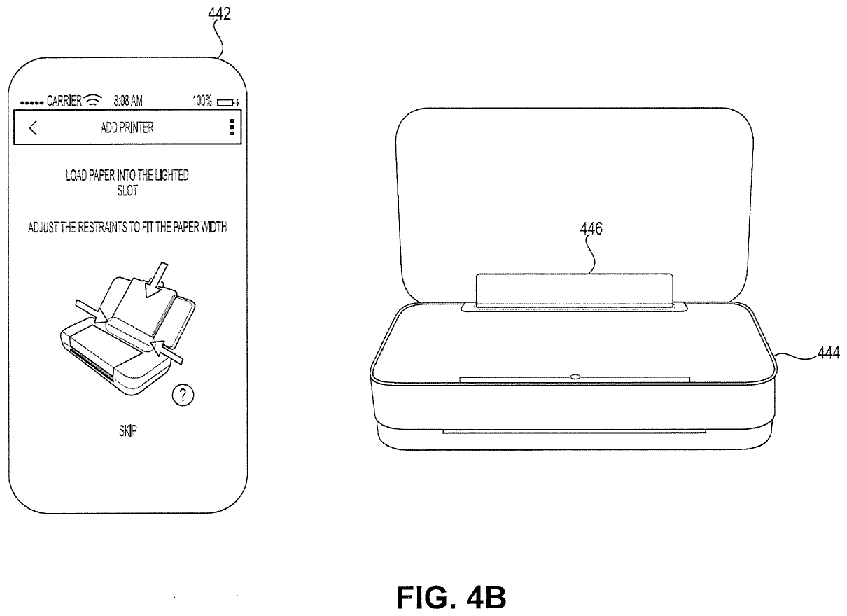

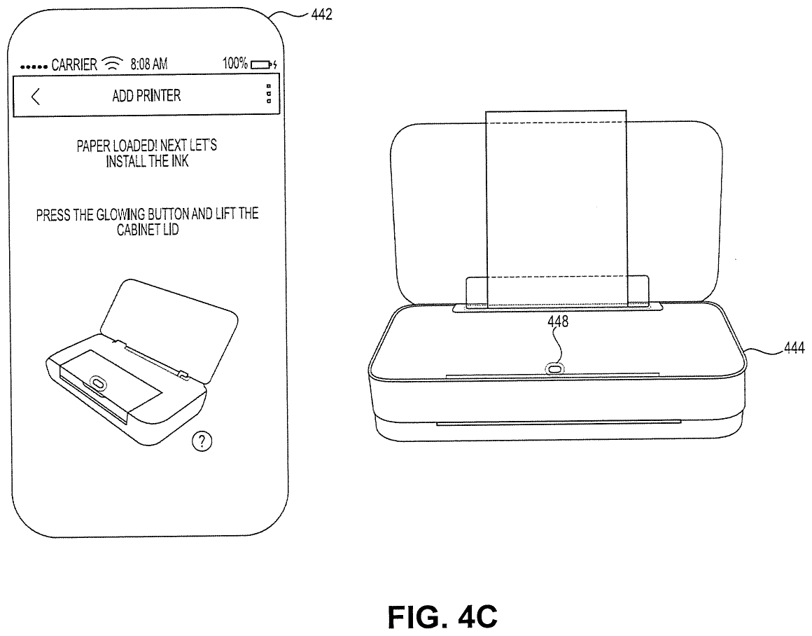

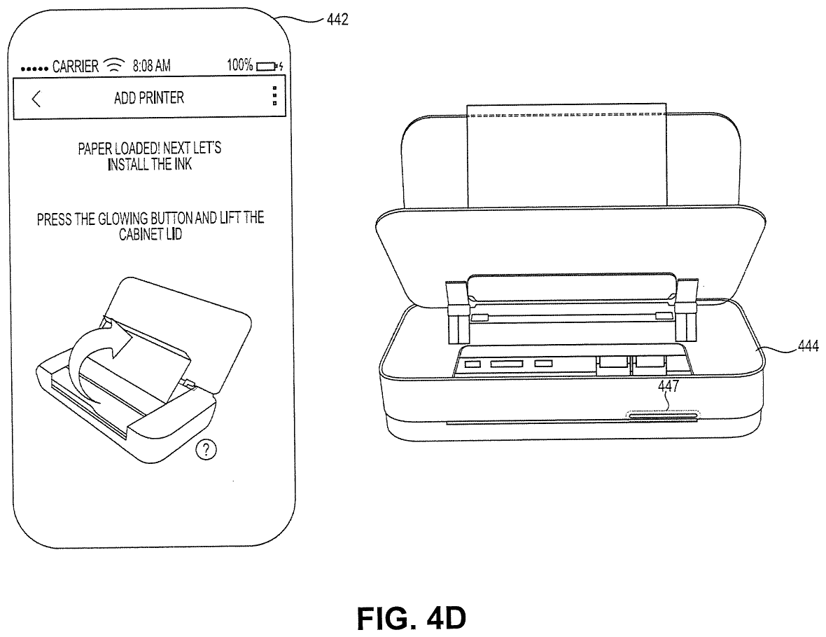

FIGS. 4A-4D illustrate example coordinated messages of a computing device and visual indications of an appliance, in accordance with the present disclosure. More specifically, FIGS. 4A-4D illustrate example messages as displayed on a computing device that are synchronized with visual indications on a printer. The printer 444 may include a plurality of light sources 437, 438, 439 used to provide indications of operational states, as described in connection with FIG. 3. In the specific example, the user is provided a plurality of messages on a mobile device 442 that instruct the user on setting up the printer 444. FIGS. 4A-4D illustrate example coordinated messages on the mobile device 442 with visual indications on the printer 444, however examples are not so limited and may include more or less messages for setting up the printer, different types of computing devices and/or appliances, and instructions unrelated to setting up the printer.

The user may provide power to the printer 444, which causes the printer to change from an off-state to an on-state. In response to booting up or otherwise initializing, the printer 444 may change to a beaconing state in which the printer 444 periodically outputs beacons that identify the printer 444. Additionally, the light sources 437, 438, 439 on the edge of the printer may provide a visual indication of the on-state and/or beaconing state. In response to mobile device 442 detecting the beacon, the mobile device 442 identifies the printer model and a visualization, such as an image, using an application program running on the mobile device 442. A message may be displayed to the user, such as the photograph and which may include a photograph of the printer with the visual indication of the on-state and/or beaconing state. In this manner, the message on the mobile device 442 is coordinated with the visual indication on the printer 444 that is specific to the current operational state of the printer 444. In response to the identification, the user may sign into a user account associated with the application program and which provides access to any previously set up appliances. In the specific example illustrated by FIG. 4A, the printer 444 is not set up and/or is not connected to WiFi. The printer 444 may communicate this operational state to the mobile device 442 such that the display of the mobile device 442 mirrors the visual indications provided by the light sources 437, 438, 439 on the edge of the printer 444 in response to receiving the data confirming the mobile device 442 identifies the printer 444. The mirrored visualization may include a same color of lighting and/or pattern of light.

In response to connecting to the application, and the WiFi, the printer 444 changes operational states. If no paper is loaded, the changed operational state may involving a non-paper loaded state. As shown by FIG. 4B, in response to the printer 444 detecting that no paper is loaded, such as by using a sensor on the paper slot, the printer 444 communicates the changed operational state to the mobile device 442 and revises the visual indication on the printer 444. The revised visual indication guides the user to the paper slot for loading the paper. The visual indication may include the illustrated light source 446 on the paper slot illuminating in a particular color and/or light pattern. The mobile device 442 provides a message that mirrors the printer 444 and that may include a visualization or animation guiding the user of where and how to properly load the paper into the printer 444. For example, an animation is provided that includes the paper slot with the associated light source 446 and moving arrows for where to adjust the restraints to fit the paper width. In a specific example, a plurality of animations are provided that illustrate lifting a lid of the printer 444 to access the paper slot, sliding open the paper restraints or guides, loading the paper and adjusting the paper restraints or guides. The user may be provided with an option to skip one or more of the instructions. The mobile device 442 receives data indicative of the message from the server that includes the visualization or animation in response to communicating the changed operational state to the server and/or as part of the data indicating of a plurality of messages. Each message may include a visualization or animation and is associated with a respective operational state of the printer 444. The printer 444 may detect correct or incorrect placement of the paper and communicate the same to the mobile device 442.

FIGS. 4C-4D illustrate example visualizations provided for guiding the user to install ink in the printer 444. As shown by FIG. 4C, the printer 444 may detect correct loading of the paper, using the paper slot located sensor, and communicates, to the mobile device 442, a changed operational state indicative of no ink loaded. The changed operational state may include a non-ink loaded state, although examples are not so limited and may include examples in which the user has already loaded the ink. In response to detection of no ink loaded, the printer 444 revises the visual indication. The revised visual indication guides the user to a button on an internal lid for installing the ink, such as the illustrated light source 448 on the button located on the internal lid, which may be referred to as an “ink door”. Opening of the internal lid may provide access to printer locations for inserting and/or installing the ink cartridges. The internal lid may be accessible to the user in response to the user lifting the (external) lid, as described in connection with FIG. 4B. The mobile device 442 provides a visual indication that mirrors the printer 444 and that may include a visualization or animation guiding the user of what actions to take to load the ink. For example, an animation is provided that includes the light source 448 on the internal lid and indicates to press the button and lift the internal lid. The button may include or be associated with a push-push mechanism that allows for lifting the internal lid. As shown by FIG. 4D, lifting of the internal lid may change the operational state of the printer, which is sensed by the printer 444 using a door sensor and communicated to the mobile device 442. The visual display illustrated by FIG. 4D may include part of an animation provided to the user in response to detecting ink is to be installed in the printer 444. In response to detecting the internal lid is open, the printer 444 revises the visual indication, such as by lighting the illustrated light source 447 on the side of the printer 444. The revised visual indication may guide the user to a location of the proper ink slots for installing the ink. Although not illustrated, further visualizations may be provided on the mobile device 442 which may guide the user to unwrap the ink cartridges and a visualization coordinated with the visual indications of printer 444 that guides the user on where to insert the ink cartridges.

The following is a specific example of a plurality of animations provided to guide the user for installing the ink. The plurality of animations illustrate pushing the button, lifting the internal lid of the printer 444 to access the ink cartridge locations or slots for installing the ink, unwrapping the ink cartridges, inserting the ink cartridges in to place, and closing the internal lid. The user may be provided with an option to skip one or more of the instructions.

Examples are not limited to the visualizations, a mobile device, and/or a printer, as illustrated by FIGS. 4A-4D. For example, the set up instructions may include more or fewer visualizations, such as coordinated visualizations indicating the printer is receiving data from the mobile device and/or is printing. Additionally, the visualizations are not limited to setting up an appliance and/or when the user is located proximal to the appliance. For example, a visualization may be provided on the mobile device that guides the user to the location of the printer to fix a problem and then guides the user through user instructions for fixing the problem.

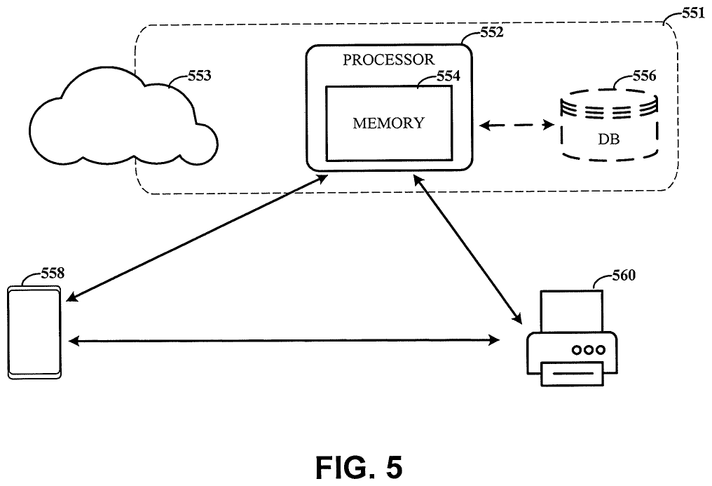

FIG. 5 illustrates an example server in an environment for coordinating messages, in accordance with the present disclosure. More specifically, the server 551 includes a memory 554 and a processor coupled to the memory 554. The server 551 may form part of a cloud network 553 and may include or be in communication with a database 556. The database 556, for example, may include messages of user instructions for a plurality of different appliances and different operational states of the different appliances.

The memory 554 stores executable instructions which may be executed by the processor 552. For example, the processor 552 may execute the instructions to identify an appliance 560 based on information as communicated from the computing device 558. In specific examples, the computing device 558 identifies the appliance from information in a beacon communicated by the appliance 560 and communicates the same to the server 551. The server identifies a model and/or type of the appliance and specific instructions or messages associated with the appliance 560, which may be stored in the database 556.

The processor 552 executes instructions to receive, from the appliance 560, data indicative of an operational state of the appliance 560. As previously described, the operational state information may be communicated from the appliance 560 to the computing device 558 and communicated from the computing device 558 to the server 551. In other examples, the operational state information is communicated from the appliance 560 to the server 551. The appliance 560 may communicate the operational state information, for example, in response to data that confirms the computing device 558 identifies the appliance 560. The data may be communicated from the computing device 558 to the appliance 560.

The processor 552 executes the instructions to provide, to the computing device 558, data indicative of a message that is specific to the appliance 560. The message may include a visualization to provide on a display of the computing device 558. As previously described, the visualization is coordinated with a visual indication on the appliance 560. The visual indication and the visualization are associated with the operational state of the appliance 560. For example, the visualization is a visual instruction indicative of user interaction with hardware of the appliance 560. In a specific example, the message includes the visualization on the computing device 558 that is synchronized with a visual light pattern on the appliance 560, and the visualization is an animation. The server 551 may provide a set of executable instructions to the computing device 558 in response to user input to the computing device 558 and/or in response to a plurality of user inputs to the appliance 560 and the computing device 558. The executable instructions including user instructions provided as a data message or a plurality of data messages, and are indicative of changes to the visualization to provide on the display of the computing device 558 that mirror changes to the visual indication on the appliance 560. Each visualization is associated with a respective operational state of the appliance 560.

In various examples, the server 551 may have access to a plurality of different messages associated with a plurality of different appliances. The plurality of different messages for each of the plurality of different appliances may be associated with different operational states of the each appliance. The messages and/or a portion thereof may be stored on the database 556 and/or the memory 554 of the server 551. The server 551 may select data indicative of the message based on the identification of the appliance 560 and the current operational state of the appliance 560.

As described above, in some specific examples, the server 551 may provide a plurality of different visualizations as part of one data message, with the plurality of visualizations having an order that is defined by the operational state of the appliance 560. The order of the visualizations may be refined in response to changes in the operational state, which may include revised operational states not defined in the data message. In such examples, the computing device 558 further communicates to the server 551 in response to a revised operational state that is not recognized by the computing device 558, and the server 551 provides additional data that includes second or third messages, as described above. In other examples, the computing device 558 communicates to the server 551 in response to each revised operational state of the server 551.

Examples in accordance with the present disclosure involve and/or are directed to providing visualizations of user instructions for interacting with an appliance which are coordinated with visual indications on the appliance. Such examples may increase usability of the appliance and user satisfaction. A user may be guided through setting up the appliance and/or resolving an issue, which may reduce an amount of printed material and/or human resources for resolving issues. In a number of examples, images and/or animations are used to supplement and/or replace written instructions and which allow for breaking up written instructions into many sub-instructions to guide the user through the process. The visualizations may reduce an amount of time for successfully interacting with the appliance, thereby increasing user satisfaction. In various examples, the visualization may be provided in a vertical or horizontal pattern, with the next visualization being display vertically or horizontally from the previous visualization. The following or next instruction may be automatically displayed, scrolled to, swiped to, or otherwise accessed via the display of the computing device, such as a user-selectable icon. The application program running on the computing device may allow the user to select preferences for each of the above options. In some examples, the application program may select default options which may be based on information of the user and/or past user preferences. Additionally, as the computing device receives data from the appliance and communicates to the cloud network, the visualization may be updated over time based on feedback of user successes and failures at following the user instructions.

Various terminology as used in the Specification, including the claims, connote a plain meaning in the art unless otherwise indicated. As examples, the Specification describes and/or illustrates aspects useful for implementing the claimed disclosure by way of various structure, such as circuits or circuitry selected or designed to carry out specific acts or functions, as may be recognized in the figures or the related discussion as depicted by or using terms such as blocks, modules, device, system, unit, controller, and/or other examples. It will also be appreciated that certain of these blocks may also be used in combination to exemplify how operational aspects have been designed and/or arranged. Whether alone or in combination with other such blocks or circuitry including discrete circuit elements such as transistors, resistors, these above-characterized blocks may be circuits coded by fixed design and/or by configurable circuitry and/or circuit elements for carrying out such operational aspects. In certain examples, such a programmable circuit refers to or includes computer circuits, including memory circuitry for storing and accessing a set of program code to be accessed/executed as instructions and/or configuration data to perform the related operation. Depending on the data-processing application, such instructions and/or data may be for implementation in logic circuitry, with the instructions as may be stored in and accessible from a memory circuit. Such instructions may be stored in and accessible from a memory via a fixed circuitry, a limited group of configuration code, or instructions characterized by way of object code.

Various modifications and changes may be made to the above description without strictly following the examples and applications illustrated and described herein. For example, methods as exemplified in the Figures may involve processes carried out in various orders, with other aspects of the examples herein retained, or may involve fewer or more processes. For instance, the instructions illustrated by FIGS. 4A-4D may occur in different orders, such as installing the ink before installing the paper. Such modifications do not depart from the scope of various aspects of the disclosure, including aspects set forth in the claims.

What is claimed is:

1. A non-transitory computer-readable medium storing a set of instructions executable by a processor to cause a computing device to:
receive, from a server in communication with the computing device and an appliance, data indicative of a message that is specific to the appliance and associated with an operational state of the appliance; and
provide the message on a display of the computing device as coordinated with a visual indication on the appliance using the received data, the message being associated with the operational state of the appliance.

2. The non-transitory computer-readable medium of claim 1, wherein the message is a visualization provided on the display of the computing device and that is synchronized to the visual indication on the appliance based on a two-way communication between the appliance and the computing device and a user input to the computing device.

3. The non-transitory computer-readable medium of claim 1, wherein the instructions are further executable to identify the appliance responsive to information received from the appliance, and the message is an animation provided on the display of the computing device and that is synchronized to the visual indication on the appliance.

4. The non-transitory computer-readable medium of claim 1, wherein the instructions are further executable to:
receive data, from the server, indicative of a second message that is associated with a revised operational state of the appliance caused by a first user input to the appliance; and
provide the second message on the display of the computing device as coordinated with a revised visual indication on the appliance, the second message being associated with the revised operational state.

5. The non-transitory computer-readable medium of claim 1, wherein the instructions are further executable to:
change a graphic on the computing device from the message to a second message in response to a first user input to the computing device; and
output data indicative of the first user input to the server and the appliance, and thereby, cause the visual indication on the appliance to change and to coordinate with the second message.

6. The non-transitory computer-readable medium of claim 1, wherein the message is indicative of a user instruction to physically interact with hardware of the appliance.

7. An apparatus comprising:
a memory to store executable instructions; and
a processor coupled to the memory, the processor and memory forming part of an appliance, wherein the processor executes the instructions to:
output information that identifies the appliance to a computing device;
responsive to receiving data indicative of the computing device identifying the appliance, provide data indicative of an operational state of the appliance to the computing device; and
provide a visual indication of the operational state on the appliance, the visual indication being coordinated with a message provided on a display of the computing device, the message being specific to the appliance and associated with the operational state of the appliance.

8. The apparatus of claim 7, further including a sensor to detect the operational state of the appliance and a communication circuit to communicate the data indicative of the operational state of the appliance to the computing device.

9. The apparatus of claim 7, further including a plurality of light sources to provide the visual indication of the operational state of the appliance.

10. The apparatus of claim 7, further including a sensor to detect a revised operational state of the appliance and a communication circuit to communicate data indicative of the revised operational state of the appliance to the computing device.

11. The apparatus of claim 10, wherein the processor is coupled to the sensor to detect the revised operational state in response to a user interaction with hardware of the appliance, and the communication circuit is to communicate the data indicative of the revised operational state of the appliance to the computing device as feedback and, thereby, revise a display of the computing device to synchronize with a revised visual indication associated with the revised operational state of the appliance.

12. An apparatus comprising:
a memory to store executable instructions; and
a processor coupled to the memory, the processor and memory forming part of a server, wherein the processor executes the instructions to:
identify an appliance based on information as communicated from a computing device;
receive, from the appliance, data indicative of an operational state of the appliance; and
provide, to the computing device, data indicative of a message specific to the appliance, the message including a visualization to provide on a display of the computing device, the visualization being coordinated with a visual indication on the appliance associated with the operational state of the appliance.

13. The apparatus of claim 12, wherein the message includes the visualization on the computing device that is synchronized with a visual light pattern on the appliance, and the visualization is an animation.

14. The apparatus of claim 12, further including a communication circuit to receive state information from the computing device as provided from the appliance to the computing device, and the visualization includes a visual instruction indicative of user interaction with hardware of the appliance.

15. The apparatus of claim 12, wherein the processor is to execute the instructions to provide executable instructions to the computing device in response to a plurality of user inputs to the appliance and the computing device, the executable instructions including user instructions provided as a plurality of messages, the plurality of messages including the message and being indicative of changes to the visualization to provide on the display of the computing device that mirror changes to the visual indication on the appliance.
